(19) United States
(12) Patent Application Publication
(10) Pub. No.: US 2019/0351271 A1
(43) Pub. Date: Nov. 21, 2019

(54) METHOD FOR AVOIDING AND EXTINGUISHING A DEFLAGRATION IN MATERIALS CAPABLE OF DEFLAGRATION

(71) Applicant: Bayer Aktiengesellschaft, Leverkusen (DE)

(72) Inventors: Heinrich MORHENN, Koeln (DE); Uwe POHL, Leverkusen (DE)

(21) Appl. No.: 16/482,948

(22) PCT Filed: Feb. 5, 2018
(86) PCT No.: PCT/EP2018/052795

§ 371 Date: Aug. 1, 2019

(30) Foreign Application Priority Data
Feb. 7, 2017 (EP) 17154966.0

(51) Int. Cl. A62C 37/36; A62D 1/00

(52) U.S. Cl. CPC A62C 37/36; A62D 1/0042

(57) ABSTRACT

The invention relates to a method for processing and/or handling solids and/or mixtures capable of deflagration, in particular for processing materials capable of deflagration in the chemical and pharmaceutical industry, wherein the processing and/or handling is carried out in an environment under a reduced pressure of <500 mbara and, when a deflagration cannot be ruled out measures for extinguishing the deflagration are commenced, where the processing and/or handling comprises one or more process steps selected from a group consisting of filtration, milling, sieving, mixing, homogenization, granulation, compacting, dispensing, drying, storage and transport in a transport vessel and also other steps in apparatuses having mechanical internals.

The invention relates to a method for processing and/or handling solids and/or mixtures capable of deflagration, in particular for processing materials capable of deflagration in the chemical and pharmaceutical industry, wherein the processing and handling is carried out in an environment under reduced pressure and the reduced pressure is only broken when a deflagration can be ruled out on the basis of particular parameters, and measures for extinguishing the deflagration are carried out when a deflagration is not ruled out.

The German technical rule for plant safety (TRAS) No. 410 defines a deflagration as follows: “A deflagration is a reaction which is triggered locally in a prescribed amount of material and from there propagates spontaneously in the form of a reaction front through the total amount of material. The speed of propagation of the reaction front is lower than the speed of sound in the material. Large amounts of hot gases, which are sometimes also combustible, can be liberated in a deflagration. The speed of deflagration increases with temperature and generally also with pressure”.

Solids capable of deflagration decompose even without the presence of atmospheric oxygen after local action of a sufficiently strong ignition source (initiation). In contrast to a fire or an explosion of an air/gas or air/dust mixture, a deflagration cannot be suppressed by exclusion of oxygen. The measure of blanketing with nitrogen or other inert gases known from explosion protection does not offer any protection against a deflagration.

Explosions are fast deflagrations with a sudden pressure and temperature rise. When the speed of sound is exceeded, a deflagration goes over into a detonation.

The materials capable of deflagration are usually organic or inorganic compounds in solid form. Organic compounds having functional groups such as carbon-carbon double and triple bonds, for example acetylenes, acetylides, 1,2-dienes; strained ring compounds such as azirines or epoxides; compounds having adjacent N atoms such as azo and diazo compounds, hydrazines, azides; compounds having adjacent O atoms such as peroxides and ozonides; oxygen-nitrogen compounds such as hydroxylamines, nitrates, N-oxides, 1,2-oxalates, nitro and nitroso compounds; halogen-nitrogen compounds such as chloramines and fluoramines; halogen-oxygen compounds such as chlorates, perchlorates, iodosyl compounds; sulfur-oxygen compounds such as sulfonyl halides, sulfonyl cyanides, and compounds having carbon-metal bonds and nitrogen-metal bonds, for example Grignard reagents or organolithium compounds, are particularly prone to deflagration.

However, many other organic compounds without the abovementioned functional groups and many inorganic compounds can also be capable of deflagration.

Basically, all materials having an enthalpy of decomposition of greater than or equal to 500 J/g are potentially capable of deflagration. Materials having an enthalpy of decomposition of 300-500 J/g which are capable of deflagration are also known. The deflagration capability of a substance has to be determined separately in each individual case.

Various test methods are known for testing the deflagration behaviour of materials and mixtures of materials.

In the UN testing manual “Transportation of Dangerous Goods, Manual of Tests and Criteria”, 5th Revised Edition, 2009, two test methods for determining the deflagration capability are described in section 23 (p. 237 ff).

In the test C.1 (“Time/Pressure Test”), 5 g of the substance to be tested are ignited in a pressure vessel having a capacity of about 17 ml. Criteria for the evaluation are attainment of a limit pressure of about 20.7 barg (barg=bar gauge) and also the time after ignition in which the limit pressure is reached.

The deflagration capability in the test C.1 is assessed as follows:
Yes, capable of quick deflagration, when the pressure within the pressure vessel increases from 6.90 barg to 20.70 barg in less than 30 seconds after ignition.
Yes, capable of slow deflagration, when the pressure within the pressure vessel increases from 6.90 barg to 20.70 barg in 30 seconds or longer after ignition.
Not capable of deflagration, when the limit pressure of 20.70 barg is not reached.

In the test C.2, a sample is introduced into a Dewar vessel having an internal diameter of about 48 mm and a height of 180-200 mm. The mixture is ignited by means of an open flame.

The deflagration capability in the test C.2 is assessed as follows:
Yes, capable of quick deflagration, when the speed of deflagration is greater than 5 mm/sec.
Yes, capable of slow deflagration, when the speed of deflagration is in the range from 0.35 mm/sec to 5 mm/sec.
Not capable of deflagration, when the speed of deflagration is less than 0.35 mm/sec, or the reaction ceases before reaching the lower mark.

Overall, a substance is classified as not capable of deflagration when the substance has not been classified as “capable of quick deflagration” in the test C.1 and as not capable of deflagration in the test C.2.

A further test for determining the deflagration capability is described in VDI2263-1 (1990, p. 13 ff.). In the test according to VDI2263-1, a substance is introduced into a glass tube which has a diameter of about 5 cm and is closed at the bottom and in which a plurality of thermocouples are installed radially offset at various heights. After local initiation (ignition) by means of a glow coil, a glow plug, a microburner or an ignition mixture of lead(IV) oxide and silicon, the progress of the decomposition is determined. Initiation is carried out from above and from the bottom of the bed. If the decomposition spreads in at least one of the experiments (ignition from above and ignition from the bottom), the material is considered to be capable of deflagration. As ignition sources, a glow coil, glow plug, microburner or an ignition mixture (silicon/lead oxide in a ratio of 3:2) are used as alternatives. The time of action and the energy input of the ignition sources are not defined further. In the standard procedure in accordance with VDI2263-1, the deflagration behaviour is measured at ambient temperature and pressure. However, it can also be measured at elevated temperature and in a closed vessel.

It is known that many materials decompose without formation of a closed front and also incompletely in the test in accordance with VDI2263-1. There is frequently formation of channels in the interior of which the decomposition progresses within the bed, while the surrounding material does not decompose. However, such behaviour represents a hazard potential for processing of a material. A person skilled in the art will select the parameters for testing of the deflagration behaviour of a material or a mixture of materials so that the situation during processing is best reproduced. Thus, a substance will, for the test in accordance with VDI2263-1, be brought to the temperature at which processing of the substance also occurs. As regards the ignition source, it can be assumed that there is no deflagration capability when still no progression of the reaction is observed generally after application of a temperature of >600° C. for 300 seconds, for example by means of a glow coil or a glow plug, the latter at an energy uptake of 40 W. In the case of the progression of the reaction, any type of continuation of the decomposition which propagates through the bed can be evaluated as a sign for deflagration behaviour, even when there is channel formation and the bed does not react with formation of a decomposition front over its full width.

A classification of pulverulent materials presenting a deflagration hazard is described in VDI report 975 (1992), page 99 ff. The materials capable of deflagration are divided into three hazard classes. While materials of the hazard class 3 must in principle not be processed in apparatuses having mechanical internals, materials of the hazard classes 1 and 2 can be processed in apparatuses having mechanical internals subject to particular prerequisites.

The preparation of solids capable of deflagration is carried out using the customary process steps known from organic and inorganic chemistry. Starting materials are usually reacted with one another in liquid form or in the form of solutions, and the desired material usually precipitates as solid. This is then separated off from the remaining liquid components and, after possibly further purification steps, drying and temporary storage is available in the desired form for dispensing and transport to customers. The desired material is optionally processed further and, for example, milled and/or mixed with other components.

The preparation of solids capable of deflagration is generally unproblematic on the laboratory scale. The amounts handled are small, the probability of initiating a deflagration is small, any deflagrations which occur are quickly recognized and even when a deflagration is not recognized and progresses, the amount of damage is small.

However, the preparation of materials capable of deflagration in larger amounts, as is carried out in pilot plant operation or in a production operation, is problematical. Here, a number of apparatuses which firstly have potential initiation sources and secondly in the case of which a deflagration which is not detected or is detected too late can lead to great damage because of the quantities handled are employed.

Apparatuses in pilot plant and production operations are frequently equipped with mechanical devices which serve to effect transport, mixing, renewal of the surface or other purposes.

Thus, for example, mixers having moving mechanical elements, for example ploughshare mixers or screw mixers, are used for homogenizing solids. It is known that the mechanical devices are one of the most frequent causes for initiation of a deflagration. Thus, in the case of a malfunction, a moving mixing element can come into direct contact with the casing of the apparatus and local heating occurs at the point of friction, which can cause the surrounding material to decompose and thus initiate a deflagration. Cases in which a foreign body, for example a screw, has got into an apparatus, there got between wall and stirring/mixing element and triggered a deflagration as a result of the heat generated are likewise known. Triggering of deflagrations has occurred even by rubbing of hard crusts or by rubbing in a blocked transport screw. It is also known that deflagrations can be carried from one apparatus into another. Thus, a screw which has been carried into a mixer can be heated by friction in the manner described. The hot screw is then, for example, discharged into a silo without mechanical internals. The temperature of the screw can still be sufficiently high in order to cause the surrounding substance to decompose in the silo and thus trigger a deflagration. In the same way, agglomerates in which a deflagrative decomposition has already been triggered can be discharged into an apparatus without mechanical internals and there initiate the deflagrative decomposition of the contents of the apparatus.

A number of measures which make safe processing of materials capable of deflagration possible are known.

The VDI report 975 (1992) page 99 ff describes a systematic procedure for assessing and selecting measures in the processing of pulverulent materials which present a deflagration hazard. The report describes a classification of the materials capable of deflagration into three hazard classes, with the materials in hazard class 3 having the greatest hazard potential and materials in the hazard class 1 having the lowest hazard potential. According to the hazard class, suitable processing methods are indicated. Although the criteria mentioned in the publication cited do not have general validity, the systematic procedure presented in this publication represents a good starting point for assessing and processing materials capable of deflagration. Further examples of safe processing of materials capable of deflagration may also be found in the VDI report 1272 (1996), page 441 ff. In the case of materials having a high deflagration tendency, it is ensured that processing is carried out without mechanical action. This occurs, for example, by drying of individual pellets being carried out in a drying oven instead of a drier having mechanical internals, for example a paddle drier. However, processing without mechanical devices is very laborious. Transport of materials frequently has to be carried out manually, which apart from the great expense can also lead to the health of operating personnel being endangered and to quality problems. Processing without a mechanical device is only taken into consideration when safe processing with mechanical devices is not possible. For example, in the publication VDI report 975 (1992), page 99 ff cited above, only processing methods without mechanical devices are provided in the case of the materials of hazard class 3.

In the case of materials in which the hazard potential posed by deflagration is less pronounced, processing can also be carried out using mechanical devices under certain conditions. In the cited publication in VDI report 975 (1992), page 99 ff, this applies to materials of the hazard classes 1 and 2.

A customary method for avoiding deflagrations is careful avoidance of introduction of foreign bodies. This can, for example, be effected by separating off metal before the material is introduced into the apparatus and preventing the carrying-over of screws and other metallic foreign bodies into the processing step.

In the construction of the apparatuses, too, attention can be paid to avoiding possible ignition sources, for example by making the distances between mechanical mixer and wall large.

The abovementioned methods for avoiding ignition sources can significantly reduce the risk of deflagration, but deflagration cannot be ruled out thereby. The methods mentioned are also complicated and in some cases associated with impairment of the performance of the apparatuses.

A further known method for safe processing of substances capable of deflagration is to safely conduct away the pressure arising in a deflagration or the gases formed in the deflagration. This can, for example, be effected by building in appropriately dimensioned bursting discs and appropriate discharge devices. It should be noted here that the speed of deflagration increases with increasing pressure, and actuation pressure and discharge have to be designed accordingly. It should also be noted that entrained substances have to be hindered at a continuation of the deflagration. This can, for example, be effected by passing the discharged gases into a water bath.

A further known method for safely processing substances capable of deflagration is to recognize the commencement of deflagration in good time and to suppress the incipient deflagration by conducting away the energy. The recognition can occur via a number of indicators. For example, the monitoring of temperature and/or pressure is known. When the triggering value is reached, the energy is removed from the system. In general, this is effected by addition of a larger amount of water. As a result of the heat capacity of the water, the deflagrating substance cools down to temperatures below the decomposition temperature. Additional removal of heat can be effected by the formation of water vapour. A detergent can be added to the water in order to ensure good wetting of the deflagrating substance. The volume increase caused by the introduction and vaporization of water has to be conducted away by means of suitable devices in order to counter an undesirable build-up of pressure.

A further method of processing and handling materials capable of deflagration is described in WO 2014/139876 A1. WO 2014/139876 A1 describes a method in which the processing and/or handling of the solids capable of deflagration is carried out in an environment under reduced pressure. WO 2014/139876 A1 describes, inter alia, the processing and handling of solids capable of deflagration in conventional chemical process steps, in particular filtration, drying, milling, sieving, mixing, homogenization, granulation, compacting, dispensing, storage and transport in a transport container, and also mechanical transport such as conveyance in transport screws or by means of star feeders. The method described in WO 2014/139876 A1 is particularly advantageous for the processing and handling of solids capable of deflagration in apparatuses having mechanical internals. While WO 2014/139876 A1 describes in detail the processing of materials capable of deflagration under reduced pressure, WO 2014/139876 A1 does not give any information as to how the materials capable of deflagration can safely be brought back to ambient pressure after ending of the respective process step or at the end of the production or handling process.

EP17154912.4 describes a method for the processing and/or handling of materials capable of deflagration under reduced pressure, in which the reduced pressure is broken only when an ignition source has been switched off and a delay time between switching-off of the potential ignition source and breaking of the reduced pressure is adhered to. The delay time is given as from 10 to 60 minutes.

However, it cannot be ruled out that in the case of materials having a strong deflagration tendency, a continuation of the deflagration with gas evolution and build-up of pressure, which can lead to failure of the apparatuses, will occur even at a reduced pressure. Neither WO 2014/139876 A1 nor EP17154912.4 offer a solution to this “nevertheless case”.

It was therefore an object of the present invention to discover a method for processing and/or handling solids capable of deflagration in an environment under reduced pressure, which has reliable measures for recognizing and extinguishing the deflagration in the case of a deflagration which has already started.

The object is achieved by a method in which measures for detecting a deflagration are undertaken and measures for extinguishing the deflagration are undertaken when a deflagration is detected in the processing and handling of a material capable of deflagration under reduced pressure.

The method of the invention can be employed for the processing and/or handling of solids and/or mixtures capable of deflagration, which is characterized in that the processing and/or handling is carried out in an environment under a reduced pressure of <500 mbara (mbara=absolute pressure in millibar), where the processing and/or handling comprises one or more process steps which are selected from a group consisting of filtration, milling, sieving, mixing, homogenization, granulation, compacting, dispensing, drying, storage and transport in a transport container and also other steps in apparatuses having mechanical internals.

The presence of a possible deflagration can be established after switching off the operation of the mechanical internals or else during continuing operation.

To detect a deflagration, one or more parameters which point to an incipient decomposition or deflagration are employed according to the invention. Such parameters are an increase in the pressure, in the temperature, the occurrence of decomposition products or other features which are measurable as a consequence of a deflagration, and also a combination of a plurality of features.

As measures for extinguishing the deflagration, the maintenance or restoration of the underpressure is preferred.

A further measure for stopping the deflagration is the introduction of an extinguishing agent into the apparatus which is under underpressure, with the extinguishing agent preferably being water or water admixed with surfactants and the pressure in the apparatus being, according to the invention, <700 mbara at the beginning of the introduction of extinguishing agent. The introduction of extinguishing agent can in each case be triggered manually by the plant operator. However, the introduction of extinguishing agent can also be triggered automatically in each case for the prescribed limit values.

An indication of an incipient deflagration is the increase in the pressure in the apparatus. If the pressure increases in the presence of an effective source of underpressure, this is a sign of an incipient deflagration. As countermeasure against the incipient deflagration, the operation of the mechanical internals can be switched off while maintaining the connection to the source of underpressure. If a self-propagating decomposition has not yet started, the decomposition is extinguished under reduced pressure. A further possible way of extinguishing the deflagration is introduction of an extinguishing agent, preferably the introduction of water or water admixed with surfactants in order to extinguish the deflagration. The introduction of the extinguishing agent can, for example, be coupled automatically to a particular limit value for the pressure, so that the quench is triggered automatically when this value is exceeded in the respective process step. The limit value has to be set in each case according to the respective process.

Before the reduced pressure is broken, it is useful to disconnect the apparatus from the source of underpressure. If a delay time is inserted between disconnection of the source of underpressure and breaking of the underpressure and the pressure is monitored during this time, a pressure increase above the leakage rate of the apparatus is a sign of an incipient deflagration. The leakage rate of the apparatus corresponds to the pressure increase which is observed as a result of various small leaks on the apparatus. The leakage rate can be determined by means of measures known to those skilled in the art before filling the apparatus with product. According to the invention, the reduced pressure is not broken in the case of a pressure increase above the leakage rate or a thermal pressure build up due to introduction of energy. Instead, countermeasures damping down an incipient deflagration are undertaken. For the purposes of the present invention, the connection to the source of underpressure is preferably reestablished in order to restore the reduced pressure and extinguish the deflagration. However, the incipient deflagration can also be extinguished by introduction of water, water admixed with surfactants or another material.

The delay time for monitoring the pressure after disconnection of the source of underpressure to breaking of the underpressure is preferably 5 minutes. Other delay times can be set down as a function of the size of the apparatus, the leakage rate, the degree of fill, the properties of the gas evolution rate. A person skilled in the art will set down the delay time for monitoring of the pressure after disconnection of the source of underpressure in the individual case as a function of the speed of deflagration and the resulting gas evolution and also the apparatus size and the free volume in the apparatus, the material to be processed and optionally further parameters. According to the invention, the period of time should be from 5 to 60 minutes, preferably from 5 to 15 minutes. If the pressure increase during the delay time corresponds to the leakage rate, the vacuum can be broken after the end of the delay time.

The drive of the potential mechanical ignition source can be switched off in the method described in the previous section by disconnection of the source of underpressure, or can still be in operation.

The drive of the potential mechanical ignition source is preferably switched off before or simultaneously with disconnection of the source of underpressure.

However, the potential mechanical ignition sources can also continue to remain in operation after disconnection of the source of underpressure. This may be necessary in some apparatuses in order to prevent, for example, agglomeration of particles or because the mechanical device for subsequent discharge of product is to be kept in motion. Here too, monitoring of the pressure and the abovementioned period of time between disconnection of the source of underpressure and the breaking of the reduced pressure offer protection against deflagration in the context of the present invention.

As long as the apparatus is connected to the source of underpressure, the underpressure source will draw off gases formed without an increase in the pressure occurring in the apparatus. In this way, the deflagration could progress further before it is detected by means of a pressure increase. In order to be able to recognize a deflagration in good time in such a case, too, further criteria apart from the pressure can be employed for detecting decomposition gases. Thus, the increased formation of decomposition gases can be detected by operating parameters of the pump, e.g. an increased power uptake or an increased torque. The determination of the gas flow at the source of underpressure can also be employed as parameter for the presence of a deflagration; an increased gas flow would point to a possible incipient deflagration. In all the above-described cases, limit values which trigger automatic actuation of the protective measure, preferably the introduction of water or of water admixed with surfactants, can be set down.

Another sign of an incipient deflagration is the increase in the temperature in the apparatus. The temperature is preferably measured in the gas phase. However, it is also possible to measure the temperature in the bed of solid. Any temperature increases caused by external heating or input of energy by the mixing device have to be taken into account in setting limit values. The energy liberated in a deflagration generally results in the temperature increase caused by a deflagration at values of >50° C.

If the temperature increases in the presence of an effective source of underpressure, this is a sign of an incipient deflagration. As countermeasure against the incipient deflagration, the operation of the mechanical internals can be switched off while maintaining the connection to the source of underpressure. If a self-sustaining decomposition has not yet been established, the decomposition is extinguished under reduced pressure. A further possible way of extinguishing the deflagration is the introduction of an extinguishing agent, preferably the introduction of water or of water admixed with surfactants to extinguish the deflagration. The addition of the extinguishing agent can, for example, be coupled automatically to a certain limit value for the temperature, so that the quench is automatically triggered when this value is exceeded in the respective process step. The limit value is in each case to be set according to the respective process.

Before the reduced pressure is broken, it is useful to disconnect the apparatus from the source of underpressure. If a delay time is inserted between disconnection of the source of underpressure and breaking of the underpressure and the temperature is monitored during this time, a temperature increase is a sign of an incipient deflagration.

According to the invention, the reduced pressure is not broken when there is an increase in the temperature. Instead, countermeasures for damping down an incipient deflagration are undertaken. For the purposes of the present invention, the connection to the source of underpressure is preferably reestablished in order to ensure the reduced pressure and to extinguish the deflagration. However, the incipient deflagration can also be extinguished by introduction of water, water admixed with surfactants or another material.

The delay time for monitoring the temperature after disconnection of the source of underpressure to breaking of the reduced pressure is preferably 5 minutes. Other delay times can be set down as a function of the size of the apparatus, the leakage rate, the degree of fill, the properties of the gas evolution rate. A person skilled in the art will set down the delay time for monitoring of the temperature after disconnection of the source of underpressure in the individual case as a function of the speed of deflagration and the resulting gas evolution and also the apparatus size and the free volume in the apparatus, the material to be processed and optionally further parameters. According to the invention, the period of time should be from 5 to 60 minutes, preferably from 5 to 15 minutes.

If the temperature in the apparatus remains constant or in the range to be expected as a result of cooling or energy input during the delay time after disconnection of the source of underpressure and breaking of the reduced pressure, the underpressure can be broken without a deflagration having to be feared.

The period of time between disconnection of the source of underpressure and breaking of the reduced pressure is set differently according to size and construction of the apparatus, the leakage rate, the degree of fill, the properties of the material to be processed and optionally further parameters. According to the invention, the period of time is from 5 to 60 minutes, preferably from 10 to 20 minutes.

The drive of the potential mechanical ignition source can be switched off after disconnection of the source of underpressure in the method described in the previous section, or can also still be in operation. The drive of the potential mechanical ignition source is preferably switched off before or simultaneously with disconnection of the source of underpressure.

However, the potential mechanical ignition sources can also continue to remain in operation after disconnection of the source of underpressure. This may be necessary in some apparatuses in order to prevent, for example, agglomeration of particles, or because the mechanical device is to remain in motion for subsequent discharge of product. Here too, the monitoring of the temperature and the abovementioned period of time between disconnection of the source of underpressure and breaking of the reduced pressure offer protection against deflagration in the context of the present invention.

A further sign of an incipient deflagration is the occurrence of decomposition gases. The decomposition gases firstly bring about an increase in pressure, the detection of which and utilization of which for securing safety has already been described in the sections above. Secondly, most decomposition gases can be detected by means of suitable sensors. It is particularly advantageous for the decomposition gases to occur with commencement of the decomposition, i.e. at a point in time at which the ignition source just becomes effective and thus before a self-sustaining decomposition, i.e. a deflagration, commences. Suitable detection of the decomposition gases thus allows an incipient deflagration to be recognized significantly earlier than is the case for a pressure and/or temperature increase or an increased gas flow. The decomposition gases formed in deflagrations are generally gases which are easy to detect, e.g. carbon monoxide, carbon dioxide, nitrogen oxides, sulfur oxides, hydrogen cyanide, cyanurates and others.

The decomposition gases have to be determined for the material to be processed, and appropriate sensors have to be installed. The sensors can be installed in the apparatus or in the connected pipes. Installation at the outlet side of the source of underpressure is likewise possible, but in this case monitoring is only possible when the source of underpressure is working. Sensors on the pressure side of the source of underpressure do not come into question for monitoring after disconnection of the source of underpressure.

The sensors are sensors which are known to a person skilled in the art and are based on spectroscopic measurement methods, electrochemical measurement methods or measurement methods based on other principles, for example UV/VIS photometry, UV fluorescence analysis, IR spectroscopy, chemoluminesce analysis, AAS, electrochemical measurement cells, etc.

If decomposition gases are detected in the presence of an effective source of underpressure, an incipient decomposition can be assumed. A possible first countermeasure against formation or progression of the deflagration is switching off the operation of the potential mechanical ignition sources while maintaining the reduced pressure. If decomposition gases are no longer detected after an appropriate time, it can be assumed that no deflagration is present or the incipient decomposition has been extinguished. The reduced pressure is broken. If appropriate, the processing can be continued. This has to be decided in the individual case taking into account the respective circumstances.

However, if the decomposition gases continue to be detected even after switching off the operation of the potential mechanical ignition sources and their concentration continues to increase, a deflagration cannot be ruled out. Appropriate countermeasures have to be undertaken. As countermeasure against the incipient deflagration, introduction of an extinguishing agent is carried out, preferably the introduction of water or water admixed with surfactants, in order to extinguish the deflagration. The introduction of the extinguishing agent can, for example, be coupled automatically to a certain limit value for the decomposition gases, so that the quench is automatically triggered when this value is exceeded in the respective process step. The limit value has to be set down in each case according to the respective process.

If decomposition gases are detected after disconnection of the source of underpressure, this can be a sign of an incipient deflagration. For the purposes of the present invention, the connection to the source of underpressure is preferably reestablished in order to restore the reduced pressure and extinguish the deflagration. However, the incipient deflagration can also be extinguished by introduction of water, water admixed with surfactants or another material.

If no decomposition gases are detected during the delay time after disconnection of the source of underpressure, the underpressure can be broken without a deflagration having to be feared.

The period of time between disconnection of the source of underpressure and breaking of the reduced pressure is set differently according to the size and construction of the apparatus, the leakage rate, the degree of fill, the properties of the material to be processed and optionally further parameters. The continual monitoring even when the source of atmospheric pressure is working makes it possible to select a very short period of time. According to the invention, the period of time is from 0.5 to 20 minutes, preferably from 1 to 5 minutes.

The drive of the potential mechanical ignition source can be switched off after disconnection of the source of underpressure in the method described in the previous section, or can also still be in operation.

The drive of the potential mechanical ignition source is preferably switched off before or simultaneously with disconnection of the source of underpressure.

However, the potential mechanical ignition source can also continue to remain in operation after disconnection of the source of underpressure. This may be necessary in some apparatuses in order to prevent, for example, agglomeration of particles or because the mechanical device is to remain in motion for subsequent discharge of product. Here too, the detection of possible decomposition gases and the abovementioned period of time between disconnection of the source of underpressure and breaking of the reduced pressure offer protection against deflagration in the context of the present invention.

A reduced pressure in the context of the present invention is a pressure range of ≤500 mbara, particularly preferably a pressure range of ≤100 mbara, particularly preferably a pressure range of ≤20 mbara. For economic and technical reasons, ≥2 mbara, preferably ≥10 mbara, is recommended as lower limit for the pressure range within the vessel.

The breaking of the reduced pressure is carried out using methods with which a person skilled in the art will be familiar Typically, the connection to the source of underpressure is firstly disconnected. In the next step, gas is fed in via a suitable feed conduit and a valve present therein. An inert gas such as nitrogen is frequently fed in in order to avoid possible oxidation reactions (which could lead to a deterioration in the quality and also to hazardous exothermic reactions). However, the introduction of air or other gases is also possible. The reduced pressure is increased to the region of atmospheric pressure, with pressures above atmospheric pressure also being able to be set. The breaking of the reduced pressure should not be carried out suddenly. The duration and intensity of the introduction of gas is set differently according to the size and construction of the apparatus, the leakage rate, the degree of fill, the properties of the material to be processed and optionally further parameters. In general, the period of time for breaking of the reduced pressure is in the range from 1 to 30 minutes. Stepwise breaking of the reduced pressure, in which the pressure is increased in a first stage up to a particular pressure below atmospheric pressure and only brought either to atmospheric pressure or to a different pressure level below atmospheric pressure in a further step, is also possible. In the case of stepwise breaking of the reduced pressure, a further check for a possible incipient deflagration is carried out at the respective pressure stages with the aid of the pressure, the temperature and/or the decomposition gases, as described above. Delay times which themselves likewise reduce the risk of a deflagration can also be set in the respective pressure stages. The pressure level can also be increased to a range above atmospheric pressure without atmospheric pressure being separately set as intermediate level in the transition from a pressure level below atmospheric pressure to a pressure above atmospheric pressure.

The method of the invention can be applied to the processing and handling of solid substances capable of deflagration, including solid substances capable of exploding.

For the purposes of the present invention, the term “capable of deflagration” refers to all materials which are to be classified as capable of deflagration either according to the criteria specified in the UN testing manual “Transportation of Dangerous Goods, Manual of Tests and Criteria”, 5th Revised Edition, 2009, Deflagration, under section 23.2.2 (Question “Can it propagate a deflagration?”—Answer “yes, rapidly” or “yes, slowly”), and/or in the test VDI2263-1 in testing at the temperature intended in processing and with ignition from above or below using an igniting pill, igniting coil or glow plug, the latter with a power uptake of at least 40 W and a time of action of 300 seconds display spontaneous decomposition, with the decomposition being able to propagate in the form of a decomposition front or in the form of decomposition channels.

Typical materials capable of deflagration for the purposes of the present inventions are organic compounds having functional groups such as carbon-carbon double and triple bonds, for example acetylenes, acetylides, 1,2-dienes; strained ring compounds such as azirines or epoxides, compounds having adjacent N atoms such as azo and diazo compounds, hydrazines, azides, compounds having adjacent O atoms such as peroxides and ozonides, oxygen-nitrogen compounds such as hydroxylamines, nitrates, N-oxides, 1,2-oxalates, nitro and nitroso compounds; halogen-nitrogen compounds such as chloramines and fluoramines, halogen-oxygen compounds such as chlorates, perchlorates, iodosyl compounds; sulfur-oxygen compounds such as sulfonyl halides, sulfonyl cyanides, and compounds having carbon-metal bonds and nitrogen-metal bonds, e.g. Grignard reagents or organolithium compounds. Solids capable of deflagration are materials in solid form capable of deflagration, with the material being in solid form either pure or mixed, e.g. being present as powder or granular materials of any particle size. For the purposes of the present invention, solids capable of deflagration also include liquids capable of deflagration which have been resorbed on solids which are not capable of deflagration and are thus present in solid form. For the purposes of the present invention, solids capable of deflagration likewise include materials in solid form which are capable of deflagration and still contain residues of water or other liquids such as solvents (moist solids). The particle size and particle size distribution are known to have an influence on the deflagration behaviour, but both of these parameters do not constitute a restriction of the present invention.

Processing and handling are, for the purposes of the present patent application, process and handling steps for producing, processing, storing and transporting solids capable of deflagration, in particular filtering, drying, milling, sieving, mixing, homogenization, granulation, compaction, dispensing, storage and transport in a transport container and also mechanical transport such as conveying in transport screws or by means of star feeders. According to the invention, the method is employed for dry mechanical processing. For the purposes of the invention, these process steps can be carried out both in or with the aid of apparatuses in which the solid being processed is moved with the aid of mechanical devices, for example in a ploughshare mixer, and also in or with the aid of apparatuses without mechanical devices, for example silos. The reduction of the pressure in the apparatuses is effected by techniques known to a person skilled in the art by means of underpressure pumps such as displacement pumps, jet pumps, rotary vane pumps, centrifugal pumps, water ring pumps, rotary piston pumps and other apparatuses suitable for generating the desired pressure.

### EXAMPLES

The invention will be described below for the mixing of 1000 kg of dichlofluanid (Euparen) with 1000 kg of kieselguhr in a paddle mixer operated under reduced pressure. The paddle drier has a volume of 5 m³. A vacuum of 50 mbar is set in the mixer by means of a vacuum pump having a pumping power of 350 m³/h. Charging is effected via a vacuum lock with running stirrer shaft. The leakage rate of the mixer was determined as 50 l/h before charging. A pressure sensor and a temperature sensor are installed in the gas space of the mixer. Water can be added via a valve at a rate of 100 m³/h to extinguish a deflagration. After the mixing operation is complete, the pressure in the mixer is brought to ambient pressure by introduction of nitrogen. (The introduction of the inert gas nitrogen ensures that the product is not damaged by possible oxidation processes).

Dichlofluanid and the mixture with kieselguhr are capable of deflagration according to the test VDI2263-1. The speed of deflagration determined in accordance with VDI2263-1 is 2 mm/sec in the case of ignition from below and 0.14 mm/sec for ignition from above. A potential ignition source is present in the mixing operation due to a running mixer blade.

### Example 1—Detection of an Incipient Deflagration By Means of a Pressure Increase and Stopping of the Deflagration by Means of a Further Reduction In the Pressure

After switching off the mixing device, the apparatus is disconnected from the vacuum source by closing the valve in the connecting conduit to the vacuum pump, but no gas is introduced to break the vacuum. A deflagration is triggered at the stirrer blade which has been heated by running along the wall and this deflagration spreads in a conical fashion around the point of ignition. The pressure increases due to the gases liberated in the decomposition. After 5 minutes, the pressure has risen to the alarm value of 70 mbar. The plant operator restores the connection to the vacuum within one minute, and the pressure is decreased to 50 mbar within 5 minutes. The pressure is kept at 50 mbar for 30 minutes, and the apparatus is subsequently disconnected again from the vacuum source by closing the valve in the connecting conduit to the vacuum pump. No further pressure increase is observed over the next 15 minutes. The reduced pressure is broken by introduction of nitrogen, and the drier can be emptied safely.

The deflagration has been extinguished in the vacuum.

### Example 2—Detection of an Incipient Deflagration By Means of a Pressure Increase and Stopping of the Deflagration By Introduction of Water

After switching off the mixing device, the apparatus is disconnected from the vacuum source by closing the valve in the connecting conduit to the vacuum pump, but no gas is introduced to break the vacuum. A deflagration is triggered at the stirrer blade which has been heated by running along the wall and this deflagration spreads in a conical fashion around the point of ignition. The pressure increases due to the gases liberated in the decomposition. After 5 minutes, the pressure has risen to the alarm value of 70 mbar. After a further 10 minutes, the plant operator restores the connection to the vacuum; when the pressure has increased to 400 mbar under this, the pressure is lowered over a period of 8 minutes to 100 mbar and increases to 150 mbar over a further 20 minutes. The plant operator activates the introduction of water; 1000 l of water are introduced and the mixing device is then switched on again.

The deflagration is stopped by the introduction of water.

### Example 3—Detection of an Incipient Deflagration By Means of an Increase in Temperature and Stopping of the Deflagration By Means of a Further Reduction In the Pressure

After switching off the mixing device, the apparatus is disconnected from the vacuum source by closing the valve in the connecting conduit to the vacuum pump, but no gas is introduced to break the vacuum. A deflagration is triggered at the stirrer blade which has been heated by running along the wall and this deflagration spreads in a conical fashion around the point of ignition. The temperature in the gas space increases due to the hot gases liberated in the decomposition. The temperature in the gas space increases to the alarm value of 40° C. after 8 minutes. The plant operator restores the connection to the vacuum within 1 minute, and the pressure is decreased to 50 mbar over a period of 5 minutes. The temperature drops to <30° C. The pressure is maintained at 50 mbar for 30 minutes; the apparatus is subsequently disconnected again from the vacuum source by closing the valve in the connecting conduit to the vacuum pump. No further temperature increase is observed over the next 30 minutes. The reduced pressure is broken by introduction of nitrogen, and the drier can be emptied safely.

The deflagration has been extinguished in the vacuum.

### Example 4—Detection of an Incipient Deflagration By Means of a Temperature Increase and Stopping of the Deflagration By Introduction of Water

After switching off the mixing device, the apparatus is disconnected from the vacuum source by closing the valve in the connecting conduit to the vacuum pump, but no gas is introduced to break the vacuum. A deflagration is triggered at the stirrer blade which has been heated by running along the wall and this deflagration spreads in a conical fashion around the point of ignition. The temperature in the gas space increases due to the hot gases liberated in the decomposition. The temperature in the gas space increases to the alarm value of 40° C. after 10 minutes. The temperature continues to increase and after a further 5 minutes reaches the switching value of 80° C., which triggers the introduction of water; 1000 l of water are introduced, and the mixing device is switched on again.

The deflagration is stopped by the introduction of water.

### Example 5—Detection of an Incipient Deflagration By Detection of the Decomposition Gases In Ongoing Operation and Stopping of the Deflagration By Switching Off the Mixer and Maintaining the Vacuum

In addition to the apparatus described for examples 1-4, an electrochemical sensor for detecting SO₂ is installed on the pressure side of the vacuum pump. The stirrer blade runs along the wall. Some dichlofluanid decomposes locally as a result of heating.

The SO₂ content in the exhaust gas from the pump increases from 0 ppm (detection limit of the sensor) to 50 ppm. The mixer is switched off. The SO₂ content in the exhaust gas decreases again after 10 minutes and after 40 minutes is back at the detection limit.
The mixer is disconnected from the vacuum source, and the reduced pressure is broken by introduction of nitrogen. The drier can be emptied safely.
A deflagration has been prevented by cooling of the potential ignition source under reduced pressure.

### Example 6—Detection of an Incipient Deflagration By Detection of the Decomposition Gases In Ongoing Operation and Stopping of the Deflagration By Introduction of Water

In addition to the apparatus described for examples 1-4, an electrochemical sensor for detecting SO₂ is installed on the pressure side of the vacuum pump.

The stirrer blade runs along the wall. Some dichlofluanid decomposes locally as a result of heating. The SO₂ content in the exhaust gas of the pump increases from 0 ppm (detection limit of the sensor) to 50 ppm. The mixer is switched off. A deflagration is triggered by the heated mixer blade. The SO₂ content in the exhaust gas continues to increase. After 15 minutes, it reaches a value of 200 ppm. The plant operator activates the introduction of water; 1000 l of water are introduced, and the mixing device is switched on again.
The deflagration is stopped by the introduction of water.

### Example 7—Detection of an Incipient Deflagration By Detection of the Decomposition Gases and Stopping of the Deflagration By Reducing the Pressure Further

In addition to the apparatus described for examples 1-4, a UV luminescence measurement cell for detecting SO₂ is installed on the drier.

After switching off the mixing device, the apparatus is disconnected from the vacuum source by closing the valve in the connecting conduit to the vacuum pump, but no gas is introduced to break the vacuum. A deflagration is triggered at the stirrer blade which has been heated by running along the wall and spreads in a conical-spherical fashion around the point of ignition.
The SO₂ content in the mixture increases from 0 mg/l (detection limit) to 0.5 mg/l. The plant operator restores the connection to the vacuum within 1 minute, and the pressure is reduced to 50 mbar within 5 minutes. The SO₂ content in the exhaust gas decreases again after 10 minutes and reaches the detection limit again after 30 minutes.
The apparatus is subsequently disconnected again from the vacuum source by closing the valve in the connecting conduit to the vacuum pump. No further increase in the SO₂ content is observed over the next 10 minutes. The reduced pressure is broken by introduction of nitrogen, and the drier can be emptied safely.
The deflagration has been extinguished in the vacuum.

### Example 8—Detection of an Incipient Deflagration By Detection of the Decomposition Gases and Stopping of the Deflagration By Introduction of Water

In addition to the apparatus described for examples 1-4, a UV luminescence measurement cell for detecting SO₂ is installed on the drier.

After switching off the mixing device, the apparatus is disconnected from the vacuum source by closing the valve in the connecting conduit to the vacuum pump, but no gas is introduced to break the vacuum. A deflagration is triggered at the stirrer blade which has been heated by running along the wall and spreads in a conical-spherical fashion around the point of ignition.
The SO₂ content in the mixer increases from 0 ppm (detection limit) to 10 mg/l. The plant operator activates the introduction of water; 1000 l of water are introduced, and the mixing device is switched on again.
The deflagration is stopped by the introduction of water.

1. Method for processing and/or handling one or more solids and/or mixtures capable of deflagration, wherein processing and/or handling is carried out in an environment under a reduced pressure of <500 mbara and a deflagration is detected before breaking of the reduced pressure and the deflagration is subsequently extinguished by maintaining or restoring the underpressure.

2. Method for processing and/or handling one or more solids and/or mixtures capable of deflagration, wherein processing and/or handling is carried out in an environment under a reduced pressure of <500 mbara and a deflagration is detected before breaking of the reduced pressure and the deflagration is subsequently stopped by introduction of an extinguishing agent into an apparatus which is under underpressure, where the extinguishing agent is optionally water or water admixed with one or more surfactants and the pressure in the apparatus is <700 mbar at beginning of an introduction of the extinguishing agent.

3. Method according to claim 1, wherein a deflagration is detected by pressure increase in an apparatus after disconnection of a source of underpressure not being greater than the leakage rate and/or a thermal buildup of pressure in the apparatus.

4. Method according to claim 2, wherein the introduction of the extinguishing agent is effected automatically when a limit value for the pressure is reached.

5. Method according to claim 1, wherein a deflagration is detected by a temperature increase in the solid or mixture capable of deflagration and/or in a gas space of an apparatus which is greater than that brought about by the introduction of energy being observed after disconnection from a source of underpressure.

6. Method according to claim 1, wherein a deflagration is detected by a temperature increase in the solid or mixture capable of deflagration and/or in gas space of an apparatus which is greater than that brought about by the introduction of energy being observed during processing in the presence of an effective source of underpressure.

7. Method according to claim 1, wherein a deflagration is detected by decomposition gases being found in an apparatus after disconnection from a source of underpressure.

8. Method according to claim 1, wherein a deflagration is detected by decomposition gases being found during processing in the presence of an effective source of underpressure.

9. Method according to claim 1, wherein the solid capable of deflagration is selected from the group consisting of acetylenes, acetylides, 1,2-dienes, azirines, epoxides, azo compounds, diazo compounds, hydrazines, azides, peroxides, ozonides, hydroxylamines, nitrates, N-oxides, 1,2-oxalates, nitro and nitroso compounds, chloramines, fluoramines, chlorates, perchlorates, iodosyl compounds, sulfonyl halides, sulfonyl cyanides, Grignard reagents and organolithium compounds.

10. Method according to claim 1, wherein the mixture comprises consists of at least one material capable of deflagration selected from the group acetylenes, acetylides, 1,2-dienes, azirines, epoxides, azo compounds, diazo compounds, hydrazines, azides, peroxides, ozonides, hydroxylamines, nitrates, N-oxides, 1,2-oxalates, nitro and nitroso compounds, chloramines, fluoramines, chlorates, perchlorates, iodosyl compounds, sulfonyl halides, sulfonyl cyanides, Grignard reagents and organolithium compounds.

11. Method according to claim 1, wherein the processing and/or handling comprises one or more processes selected from the group consisting of filtration, milling, sieving, mixing, homogenization, granulation, compacting, dispensing, drying, storage and transport in a transport container and also other steps in apparatuses having mechanical internals.
